(19) United States
(12) Patent Application Publication
(10) Pub. No.: US 2017/0004453 A1
(43) Pub. Date: Jan. 5, 2017

(54) JOB TYPE RECOMMENDATION ENGINE

(71) Applicant: LinkedIn Corporation, Mountain View, CA (US)

(72) Inventors: Alicia Lin, Santa Clara, CA (US); Itamar Orgad, Sunnyvale, CA (US); Aaron William Levin, Mountain View, CA (US); Jonathan Karpfen, San Francisco, CA (US)

(21) Appl. No.: 14/788,702

(22) Filed: Jun. 30, 2015

(51) Int. Cl. G06Q 10/10; H04L 29/06; G06Q 50/00; H04L 29/08

(52) U.S. Cl. CPC G06Q 10/1053; H04L 67/306; H04L 65/403; G06Q 50/01

(57) ABSTRACT

An online social networking service receives from a user a skill, a major area of study, and/or a degree. The service uses profiles of other users to identify the other users who have similar skills, similar major area of study, and/or a similar degree. The service extracts from the profiles of the identified other users job types that are associated with the identified other users, and provides to the user information relating to the one or more job types associated with the identified other users.

### RELATED APPLICATIONS

This application is related to U.S. Provisional Application No. 62/155,415, filed on Apr. 30, 2015 and entitled “User Interface for Career Path Options,” and is further related to U.S. Provisional Application No. 62/155,413, filed on Apr. 30, 2015 and entitled “Model Generator for Career Path Options,” both of which are incorporated herein by reference in their entireties.

### TECHNICAL FIELD

The present disclosure generally relates to the technical field of online social networking services, and in one embodiment, to analyzing a vast array of information maintained by an online social networking service with respect to job types and/or careers of members of the online social networking service as to be able to provide one or more of the members with recommended job types, particular jobs, and/or career path options.

### BACKGROUND

An online social networking service, such as LinkedIn, may allow members to declare information about themselves, such as their professional qualifications or skills. In addition to information the members declare about themselves, an online social networking service may gather and track information pertaining to behaviors of members with respect to the online social networking service and social networks of members of the online social networking service. Analyzing a vast array of such information may help to come up with solutions to various problems that may not otherwise have clear solutions.

### DESCRIPTION OF THE DRAWINGS

Some embodiments are illustrated by way of example and not limitation in the accompanying drawings, in which:

FIG. 1 is a block diagram of the functional modules or components that comprise a computer-network based online social networking service, including application server modules consistent with some embodiments of the invention;

FIG. 2 is a block diagram depicting some example application server modules of FIG. 1;

FIGS. 3A and 3B are a flow diagram illustrating an example method of generating and communicating information pertaining to one or more job types, job listings, and/or career path options for presentation to a member of a social networking system in a user interface;

FIG. 4A is an example user interface for use in accepting data about a member of an online social networking service in connection with a method for generating and communicating information pertaining to one or more job types, job listings, and/or career path options for presentation to the member;

FIG. 4B is an example user interface for use in providing recommended job types, job listings, and/or career paths options to a member of an online social networking service;

FIG. 4C is an example user interface for recommending job types and/or job listings to a member of an online social networking service and listing members who have attended the same college or university as the member;

FIG. 4D is an example user interface for providing job search tips to a member of an online social networking service;

FIG. 4E is an example user interface for providing to a member of an online social networking service a list of other members who have earned the same degree as the member;

FIG. 4F is an example user interface for providing to a member of an online social networking service a recommended job;

FIG. 4G is an example user interface for allowing a member of an online social networking service to add skills to the member's profile;

FIG. 4H is an example user interface for providing to a member of an online social networking service a description of a job type; and

FIG. 5 is a block diagram of a machine in the form of a computing device within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations, permutations, and combinations of the various features and elements described herein.

The present disclosure describes methods, systems, and computer program products for providing a member of an online social networking service with information pertaining to recommended job types and/or career path options that may be available to the member. Additionally, particular job openings that involve the recommended job types and/or career path options can be provided to the member. In a particular embodiment, the member of the online social networking service is a college student who is trying to determine potential job types and career paths that are available to someone who has his or her area of study and/or degree. The system then recommends job types, particular job openings, and/or career paths to the college student based on the skills, major area of study, and/or the degree earned by the college student. In another embodiment, the job types and career paths of other members of the online social networking service who attended the same college or university and who received the same degree as the member are particularly considered.

A member of an online social networking service may declare one or more educational and/or professional qualifications, but not be aware of what types of jobs and/or career paths that those educational and/or professional qualifications may lead to. For example, for a college student on the way to earning a college degree in economics, that student may not realize that an economics degree may qualify one for such job types as business analyst, investment analyst, market analyst, stock broker, and foreign trade broker. The college student will also not likely know of how people with degrees in economics have advanced in their careers.

An online social networking service may have a vast array of information pertaining to other members, including data items pertaining to education, work experience (e.g., job types), skills, or other qualifications of each other member at particular points during their careers. An analysis of the information may expose one or more job types and/or career path options for a particular member that the member may not be aware of. For example, an analysis of the information may show one or more traditional job types and/or career paths or one or more non-traditional job types and/or career paths that other members situated similarly to the member in years past, elected to take. Additionally, an analysis of the information may show the most efficient routes that a member may take to transition from being a college student to a position in a particular job, job type, or career.

In various embodiments, an online social networking service may analyze vast amounts of data representing job types and careers of members of the online social networking service to identify possible job types, job openings, and/or careers for a particular member of the online social networking service, such as the college student looking for his or her first job. In various embodiments, the online social networking service may identify possible mentors for the member. Thus, for example, a member who received the same degree from the same college or university as a college student looking for that first job may be identified as a potential mentor for that college student. The college student may then be notified of the member or vice versa. Upon mutual agreement, the college student may be introduced to the member via the online social networking service. Similarly, college students who are seeking that first job may be introduced to members who have taken particular routes—independently of whether the members attended the same college or university as the college student.

In various embodiments, a back-end algorithm may be configured to identify the true abilities of a member based on information that the member specifies about herself or himself (e.g., profile data—skills, major area of study, degree earned), information that the system collects pertaining to the member (e.g., behavior data, such as articles read, pages browsed, messages posted, connections made, or other actions), information about declared or acknowledged connections of a member (e.g., social graph data), and so on. After the true abilities of the member have been identified, several job types and/or career path options for the member may be identified (e.g., based on an analysis of the true abilities of other members of the online social networking service that were situated similarly to the member in years past). Various job types and/or career path options may be presented to the member in a user interface. Additionally, information pertaining to work experience, skills, education, or other requirements of each career path may be presented to the member. Moreover, one or more particular individuals who represent what a member may become with respect to each career path may be identified. Various options for allowing the member to engage with these particular individuals may then be presented to the member.

In various embodiments, a method of identifying and communicating job types, job openings, and/or career path options for presentation to a member of an online social networking service are disclosed. A member of the online social networking service inputs one or more of a skill of the member, a major area of study of the member, and a degree earned by the member. The online social networking service, using profiles of other members of the online social networking service, identifies the other members of the online social networking service who have the same or similar skill as the user, the same or similar major area of study as the user, or the same or similar degree as the user. The online social networking service extracts from the profiles of the identified other members one or more job types associated with the identified other members. The online social networking service then provides to the member information relating to the one or more job types associated with the identified other members.

Other advantages and aspects of the present inventive subject matter will be readily apparent from the description of the figures that follows.

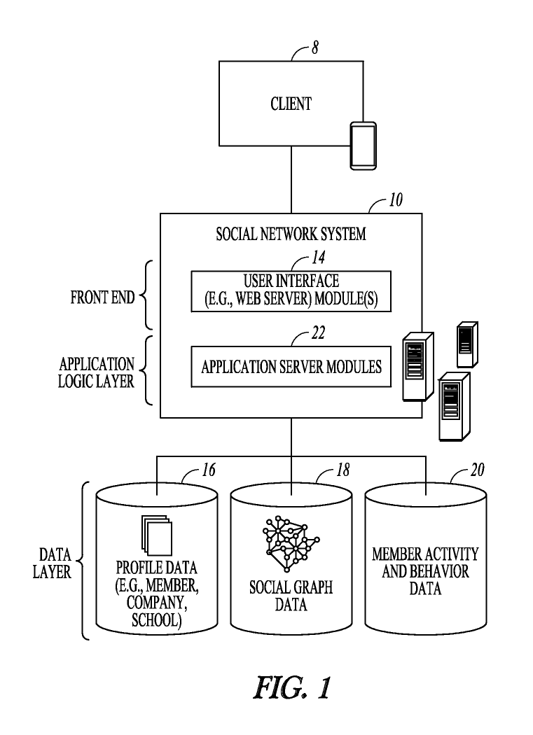

FIG. 1 is a block diagram of the functional modules or components that comprise a computer-based or network-based online social networking service 10 consistent with some embodiments of the invention. As shown in FIG. 1, the online social networking service 10 is generally based on a three-tiered architecture, comprising a front-end layer, application logic layer, and data layer, and can communicate with a client device 8. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with an online social networking service, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end comprises a user interface module (e.g., a web server) 14, which receives requests from various client-computing devices, and communicates appropriate responses to the requesting client devices. For example, the user interface module(s) 14 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. With some embodiments, these entities include members, companies, and/or educational institutions, among possible others. Consistent with some embodiments, when a person initially registers to become a member of the online social networking service, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's profile, for example, in the database with reference number 16. With some embodiments, a member's profile data will include not only the explicitly provided data, but also any number of derived or computed member profile attributes and/or characteristics.

Once registered, a member may invite other members, or be invited by other members, to connect via the online social networking service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data maintained in a database 18. With some embodiments a social graph data structure may be implemented with a graph database 18, which is a particular type of database that uses graph structures with nodes, edges, and properties to represent and store data. In this case, the social graph data stored in database 18 reflects the various entities that are part of the social graph, as well as how those entities are related with one another.

With various alternative embodiments, any number of other entities might be included in the social graph, and as such, various other databases may be used to store data corresponding with other entities. For example, although not shown in FIG. 1, consistent with some embodiments, the system may include additional databases for storing information relating to a wide variety of entities, such as information concerning various online or offline groups, job listings or postings, photographs, audio or video files, and so forth.

With some embodiments, the online social networking service may include one or more activity and/or event tracking modules, which generally detect various user-related activities and/or events, and then store information relating to those activities/events in the database with reference number 20. For example, the tracking modules may identify when a user makes a change to some attribute of his or her member profile, or adds a new attribute. Additionally, a tracking module may detect the interactions that a member has with different types of content. Such information may be used, for example, by one or more recommendation engines to tailor the content presented to a particular member, and generally to tailor the user experience for a particular member.

The application logic layer includes various application server modules 22, which, in conjunction with the user interface module(s) 14, generates various user interfaces (e.g., web pages) with data retrieved from various data sources in the data layer. With some embodiments, individual application server modules 22 are used to implement the functionality associated with various applications, services and features of the online social networking service. For instance, a messaging application, such as an email application, an instant messaging application, or some hybrid or variation of the two, may be implemented with one or more application server modules 22. Of course, other applications or services may be separately embodied in their own application server modules 22.

The online social networking service may provide a broad range of applications and services that allow members the opportunity to share and receive information, often customized to the interests of the member. For example, with some embodiments, the online social networking service may include a photo sharing application that allows members to upload and share photos with other members. As such, at least with some embodiments, a photograph may be a property or entity included within a social graph. With some embodiments, members of an online social networking service may be able to self-organize into groups, or interest groups, organized around a subject matter or topic of interest. Accordingly, the data for a group may be stored in a database (not shown). When a member joins a group, his or her membership in the group will be reflected in the social graph data stored in the database with reference number 18. With some embodiments, members may subscribe to or join groups affiliated with one or more companies. For instance, with some embodiments, members of the online social networking service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data of the database with reference number 18.

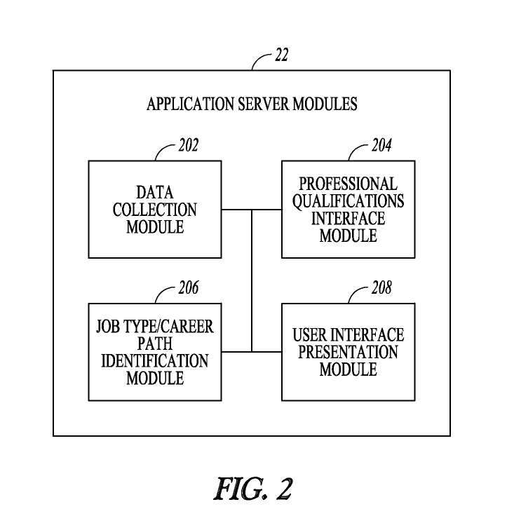

FIG. 2 is a block diagram depicting some example application server modules 22 of FIG. 1. A data collection module 202 may be configured to collect job type and/or career path data corresponding to members of an online social networking service. Such data may include profile data, behavior data, and online social networking service data. A professional qualification inference module 204 may be configured to make inferences about professional qualifications of members of the online social networking service. The inferences may be based on an application of a Hidden Markov Model (HMM) or various algorithms. A job type/career path identification module 206 may be configured to identify one or more job types and/or career paths for members of the online social networking service. The job types may be directly extracted and/or inferred from a member's profile, such as from a person's job title while employed at a particular company. The career paths may be identified based on a comparison between data corresponding to a member and data corresponding to other members who were similarly situated to the member at a previous time. Furthermore, job type/career path identification module 206 may calculate probabilities that a member will follow each of the identified career paths based on career path scores, the HMM, a comparison algorithm, and other data or algorithms. A user interface presentation module 208 may be configured to generate a user interface for presentation to the user. The user interface may include information pertaining to identified job types and/or career paths, and also may include probabilities corresponding to the career paths. Furthermore, the user interface may illustrate career gaps between a member and other members with respect to various career paths.

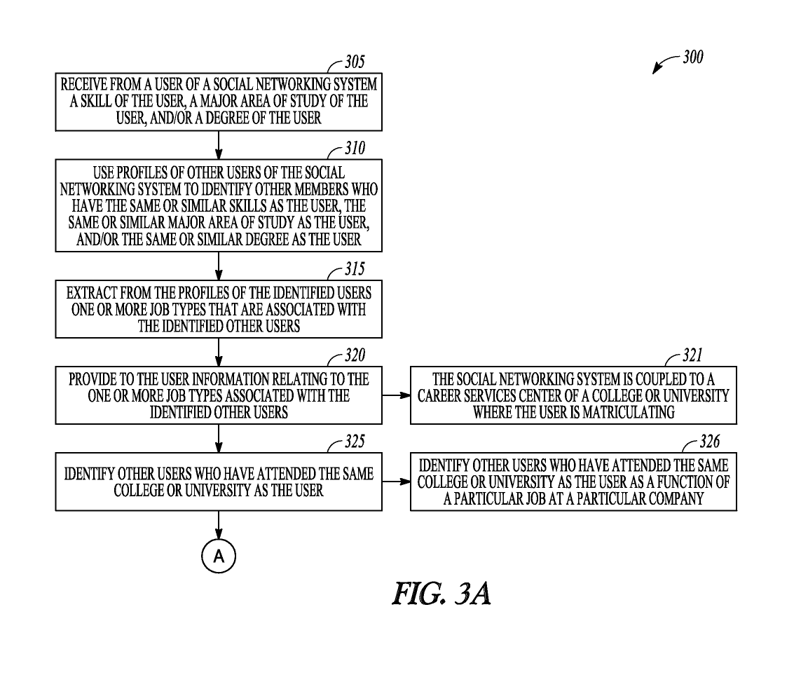

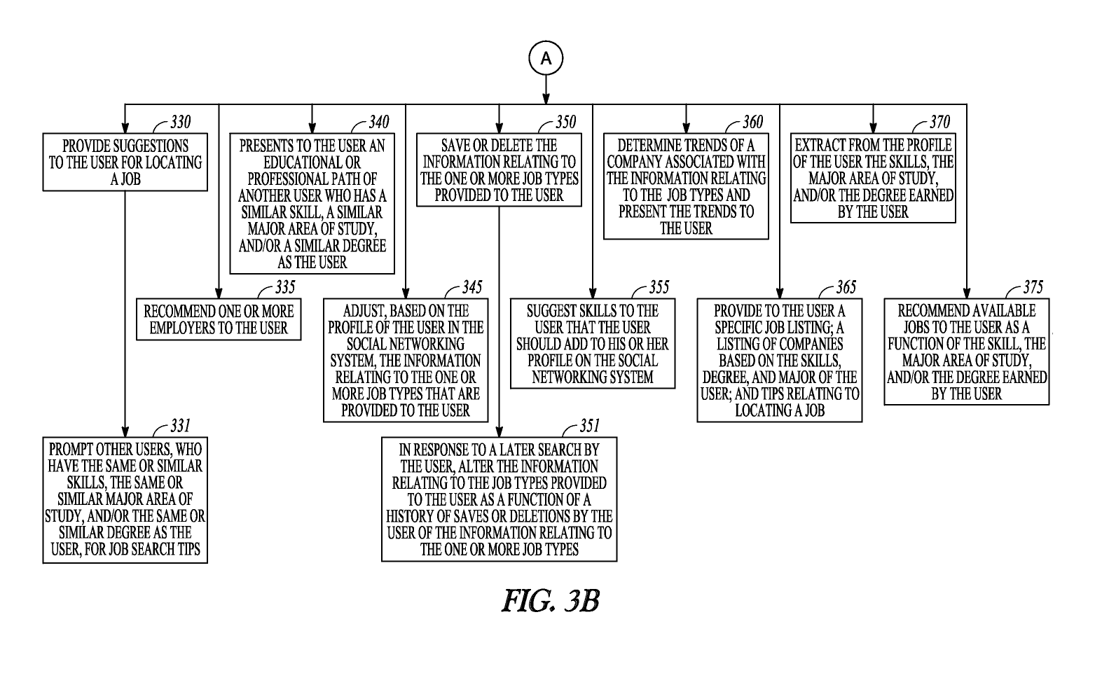

FIGS. 3A and 3B are a flow diagram illustrating an example method 300 of generating and communicating information pertaining to one or more job types and/or career path options for presentation to a member of an online social networking service in a user interface. In various embodiments, the method 300 may be implemented by one or more of the modules of FIG. 2. FIGS. 3A and 3B include a number of process blocks 305-375. Though arranged serially in the example of FIGS. 3A and 3B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

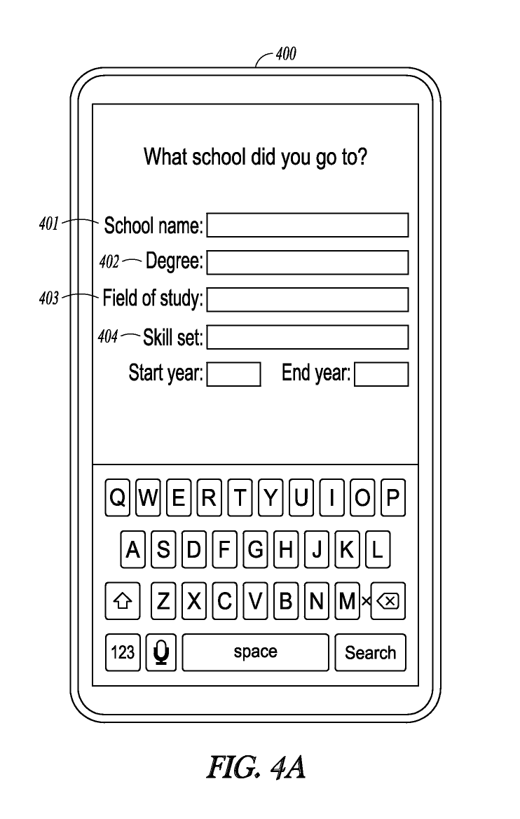

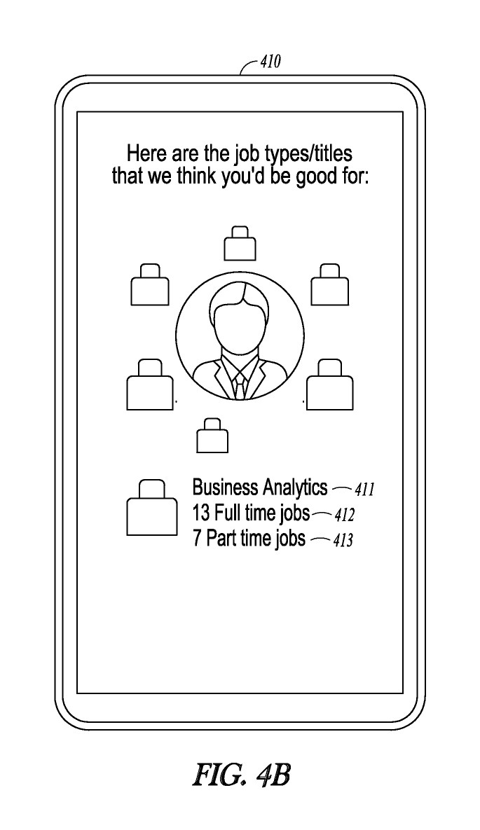

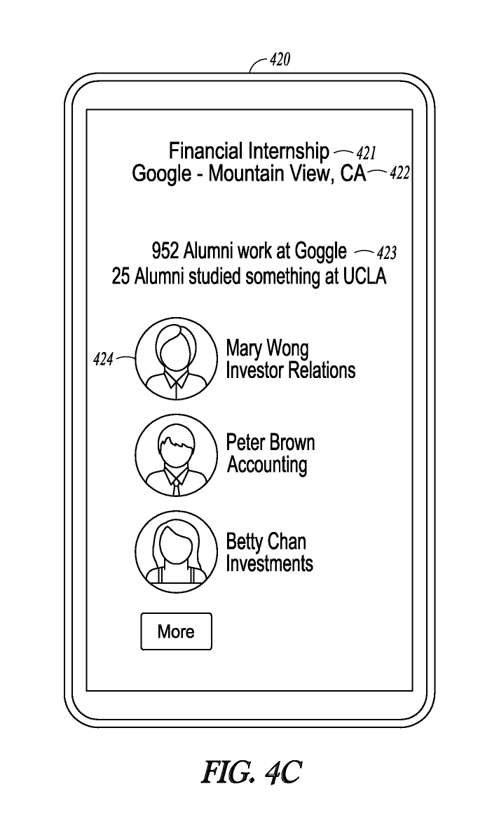

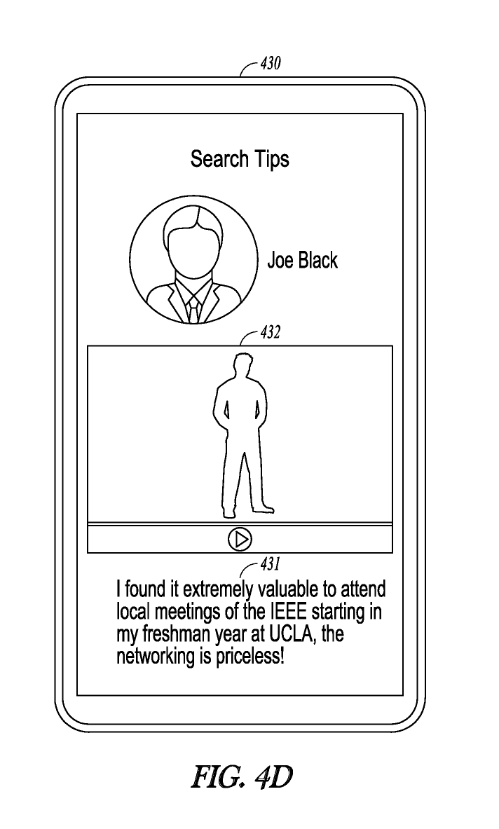

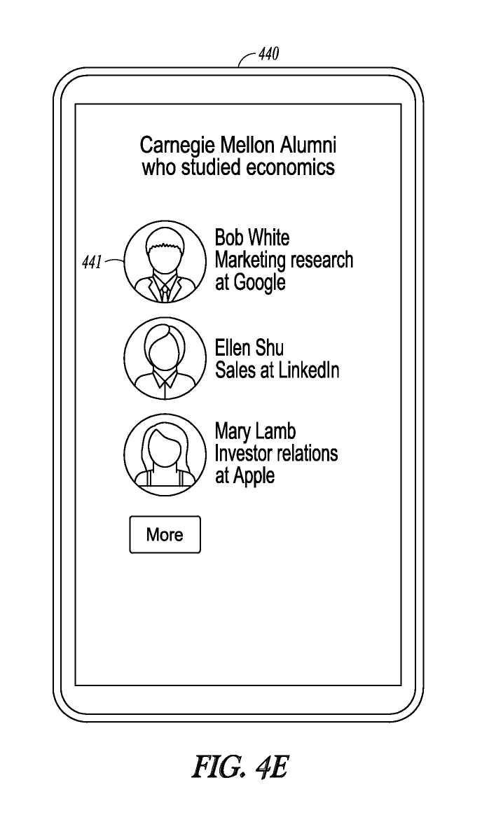

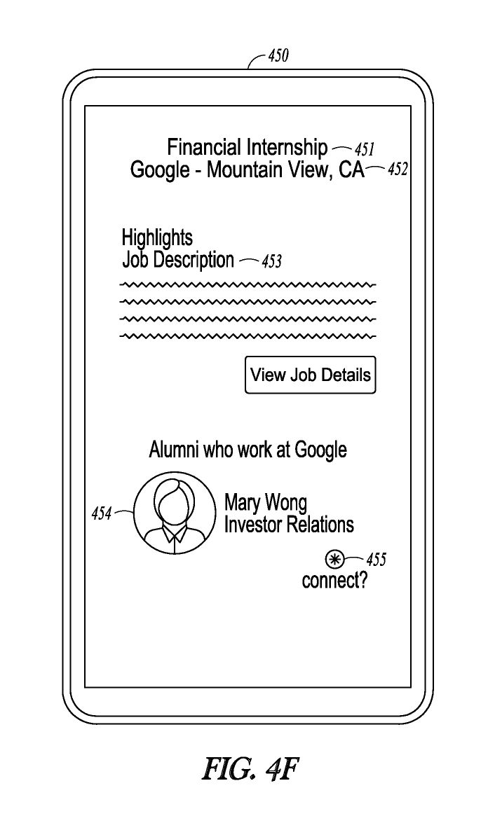

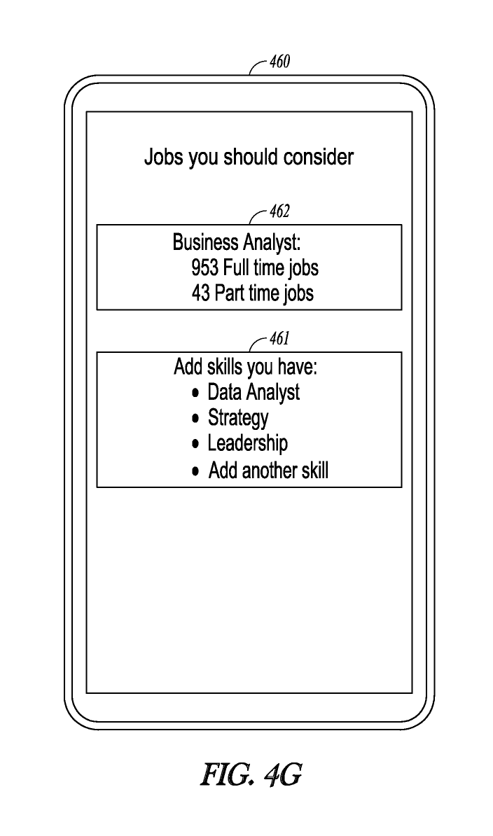

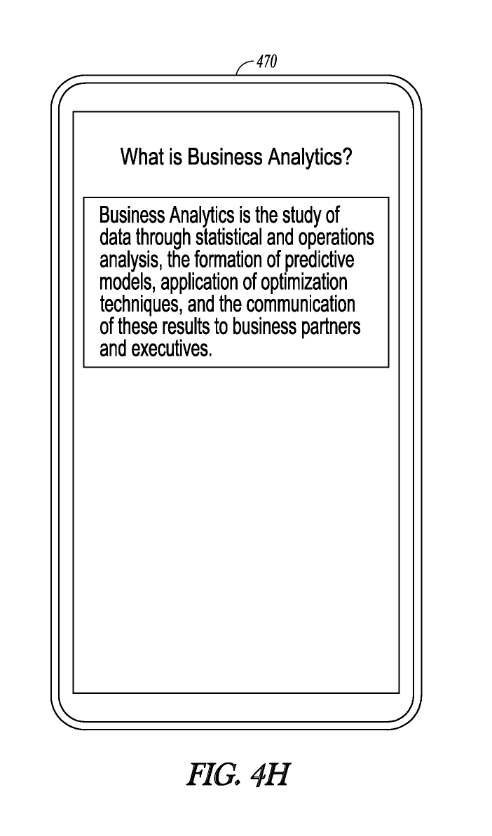

Referring specifically to FIGS. 3A and 3B, at 305, an online social networking service receives from a member or other user of the online social networking service one or more of a skill of the member, a major area of study of the member, and/or a degree earned of the member. This input can be received by the data collection module 202. After a user logs on, the online social networking service presents the user interface 400 illustrated in FIG. 4A to the member, which the member uses to input the skills 404, major area of study 403, degree 402, and college or university 401. In this example, the user interface is directed to a college student who is exploring job types, job openings, and/or career paths that are available based on the student's degree, field of study, skill set, and college or university attended.

At 310, the online social networking service uses profiles of other members or users of the online social networking service to identify the other members who have the same or similar skills as the member (or college student), the same or similar major area of study as the member, and/or the same or similar degree as the member. In a typical case, these other members are people who are professionally employed in the workplace, and as noted have some type of educational background in common with the member. Then, at 315, the online social networking service extracts from the profiles of the identified members one or more job types that are associated with the identified other members. The professional qualifications inference module 204 can be invoked to execute operations 310 and 315. For example, the professional qualifications inference module 204 can examine the employment histories of the other members, and extract data such as job titles and job positions for inferring job types. A table can also be created and used to identify similar or related job types. For example, if the system has determined over time that persons in marketing positions sometime move into trade show management positions, this relationship can be stored in a database table, and the job type of trade show management can be presented to the member whenever the system determines that a marketing job type may be suitable to the member based on the member's skills, field of study, and degree. At 320, the online social networking service provides to the member information relating to the one or more job types associated with the identified other members. Once again, when the member is a college student who may not be entirely sure about what types of jobs he or she may be suited for with his or her degree, the online social networking service provides to that college student a plurality of job types that other members of the online social networking service who have earned the same degree or have the same field of study are employed in. FIG. 4B illustrates a user interface 410 that provides to the member a job type 411 that may be suitable for the member (based on the member's degree, field of study, and skill set). The interface 410 can further list the number of full time positions 412 and part time positions 413. If the member clicks on either the full time positions 412 or part time positions 413, the online social networking service can display a user interface 420, as illustrated in FIG. 4C. The user interface 420 provides a particular job position 421 at a particular company 422, and further lists the number of people 423 who are employed at the company 422 and who attended the same college or university as the member. User interface 420 also lists by name and job title the persons 424 at the company 422 who attended the same college or university as the member.

In another embodiment, as indicated at 321, the online social networking service is coupled to a career services center of the college or university where the member is matriculating. Consequently, in addition to providing the plurality of job types and/or job openings to the member, the online social networking service can provide the plurality of job types and/or job openings to the student's associated career service center and/or career counselor. The career counselor can then examine these results, discuss these results with the student, and both the counselor and student can plan the student's course of action in a job search and/or career planning.

As noted above, an embodiment involves an online social networking service that recommends job types and/or job openings to a member college student based on that college student's skills, and more particularly, based on the college student's major field of study and degree earned. In another embodiment, as indicated at 325, the online social networking service identifies other members who have attended the same college or university as the college student. Then, more specifically at 326, the other members who have attended the same college or university as the college student are identified as a function of a particular job at a particular company. Additionally, as the user interface 440 illustrates in FIG. 4E, the online social networking service can provide to the college student or other member the persons 441 who have attended the same college or university as the college student and who have studied in the same field of study or earned the same degree as the college student. This additional information of a particular job at a particular company can be useful information to the college student. First, there is a close relationship between a particular job and a job type (and in some cases the two may be virtually the same). Second, this information provides the college student not only the job type that may be suitable to him or her, but an identification of a company that employs people in that job type, and that has hired people who have attended the same college or university as the student. Additionally, as indicated above, upon a mutual agreement, a mentoring relationship may be established between the college student and the identified member.

As indicated at 330, the online social networking service can provide suggestions to the member for locating a job. These suggestions are based on one or more of the skills of the member, the major area of study of the member, and the degree earned by the member. These suggestions can be stored in as part of a member's profile data 16, and extracted by the data collection module 202. As further indicated at 331, the user interface presentation module 208 can prompt other members who have the same or similar skills as the member, the same or similar major area of study as the member, or the same or similar degree as the member, for such job search tips. The user interface presentation module 208 then stores the job search tips according to one or more of the associated job type, skill set, field of study, and/or educational degree, and a college student can then search for such job search tips based on these factors. FIG. 4D illustrates an example user interface 430 that includes a job search tip 431. The job search tip can also be communicated by a posted video clip 432.

In addition to recommending one or more job types and/or job openings to a member or other user, as indicated at 335, the online social networking service can recommend one or more employers to the member. This recommendation of employers to the member can be based on one or more of the skills of the member, the major area of study of the member, and the degree earned by the member. It can further be based on the determination by the online social networking service that a particular employer has hired and employs a plurality of persons who attended the same college or university as the member. For example, as illustrated in the user interface 420 in FIG. 4C, the member can be presented with a particular job opening 421 and a particular company 422. The user interface 420 can further disclose to the member the number of alumni 423 employed at the company 422, and particular members 424 employed at the company 422. This type of information can of course be very useful to the member, who can then first identify a particular job type in which he or she is interested, and then pursue the companies that employ people in those job types who have earned the same degree from the same college or university as the member.

At 340, the online social networking service presents to the member, college student, or other user an educational or professional path of another member who has one or more of the same or similar skills as the member, the same or similar major area of study as the member, and the same or similar degree as the member. Specifically, the job type/career path identification module 206 can be invoked to provide this feature. The job type/career path identification module 206 accesses the profiles of identified other members, and examines the employment histories of the other members. The job type/career path identification module 206 can then provide to the member suggested career paths that include job titles/positions, companies, and time periods in these job positions/companies. Similarly, the job type/career path identification module 206 can examine the educational history of the identified other members, and can provide a suggested educational path to the member based on the undergraduate and graduate educational histories of the identified other members.

In a particular embodiment, as indicated at 345, the online social networking service adjusts, based on the profile of the member in the social networking system, the information relating to the one or more job types and/or job openings that are provided to the member in the user interface illustrated in FIG. 4B. In a first embodiment, the profile of a member can directly indicate the job types and/or job openings that the member may or may not be interested in. The online social networking service can then filter the information on the job types and/or job openings gleaned from the identified members based on this information in the member's profile. In a second embodiment, the job type/career path identification module 206 analyzes data and infers what information should be filtered out before being presented to the member. For example, if the online social networking service can learn from the member's profile that the member is an outdoor activity type of person who likes to travel (e.g., via the groups to which the member belongs), then the online social networking service can filter out job types, particular jobs, or particular companies that don't seem to offer positions or careers that fit what was learned from the member's profile.

In another embodiment related to the embodiment disclosed at operation 345, the online social networking service saves or deletes the information relating to the one or more job types and/or job openings provided to the member, as indicated at 350. This saving or deleting is based on input received from the member. Then, at 351, in response to a later search by the member, the online social networking service alters the information relating to the one or more job types and/or job openings provided to the member as a function of a history of saves or deletions by the member of the information relating to the one or more job types and/or job openings. For example, if over a period of time the member is presented with a particular job type or job opening, and the member actively deletes that particular job type and/or job opening, then the online social networking service can learn that the member is simply not interested in that particular job type and/or job opening. Such a machine learning can be as simple as noting that the member is not interested in a particular job type and/or job opening after the member has deleted a threshold number of that job type and/or job opening (e.g., five deletions). Similarly, if the member saves many, most, or all of another particular job type and/or job opening, then that indicates that the member is interested in that particular job type and/or job opening, and the online social networking service can continue to present jobs associated with that particular job type and/or job opening to the member.

At 355, the online social networking service suggests one or more skills to the member that the member should add to his or her profile on the online social networking service. These suggested skills are based on the skills in the profiles of the other members. For example, if the profile of the member lists a skill of motorcycle repair, and the profiles of other members who list motorcycle repair also list small engine repair and mechanical engineering as a skill, the online social networking service can suggest to the member to broaden the skill set in his or her profile to include small engine repair and mechanical engineering. This may be particularly useful for a member who is studying electrical engineering, but who has a keen interest in motorcycles and other related technologies. The suggestion to expand his or her skill set in this manner will open up new job types and job opportunities to the member, encourage the member to expand his or her course work (to include some mechanical engineering), and expand the member's concept of potential career paths. FIG. 4G illustrates an example user interface 460 wherein the member is presented at 461 other skills that the member may want to consider adding to his or her profile. These suggestions can be provided to the member via a dedicated screen, or in connection with listing a job type 462 in which the member may be interested. In another embodiment, the social networking system can generate a user interface 470 as illustrated in FIG. 4H that provides a short discourse on what a particular job type involves.

At 360, the online social networking service determines one or more trends of a company associated with the information relating to the one or more job types, and presents the one or more trends to the member. For example, the online social networking service can determine that a particular job type is either increasing or decreasing in the number of employed positions for a particular company. The member can then steer his or her interest to job types that are increasing in numbers and steer away from job types that appear to be waning. Alternatively, the member can seek out other companies wherein the particular job type seems to be on the rise. The online social networking service can also present these trends on an industry by industry basis.

In addition to providing strictly job types to a member (which also imply a suggested career path to the member), as indicated at 365, the online social networking service can provide to the member a specific job listing; a listing of companies based on the skills, degree, and major of the member; and tips relating to locating a job. FIG. 4F illustrates an example user interface 450, wherein the user interface 450 displays the job position 451, the company 452, the job description 453, and persons 454 who work at the company 452 who also attended the same college or university as the member. The user interface 450 further illustrates that the member can request a connection 455 with the person 454 to establish a mentoring relationship.

As indicated at operation 305, the online social networking service receives via the user interface 400 illustrated in FIG. 4A one or more of skills, field of study, and degree earned from a member. In another embodiment, at 370, the online social networking service extracts from the profile of the member the skills of the member, the major area of study of the member, and the degree earned by the member. In this manner, the online social networking service can automatically suggest job types and/or job openings to the member, for example by sending emails or text messages to the member.

At 375, the online social networking service recommends one or more available jobs to the member as a function of the skill of the member, the major area of study of the member, and the degree earned by the member. In an embodiment, after the online social networking service identifies a job type for the member, the online social networking service can use the job type to further identify particular jobs that may be suitable for the member.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

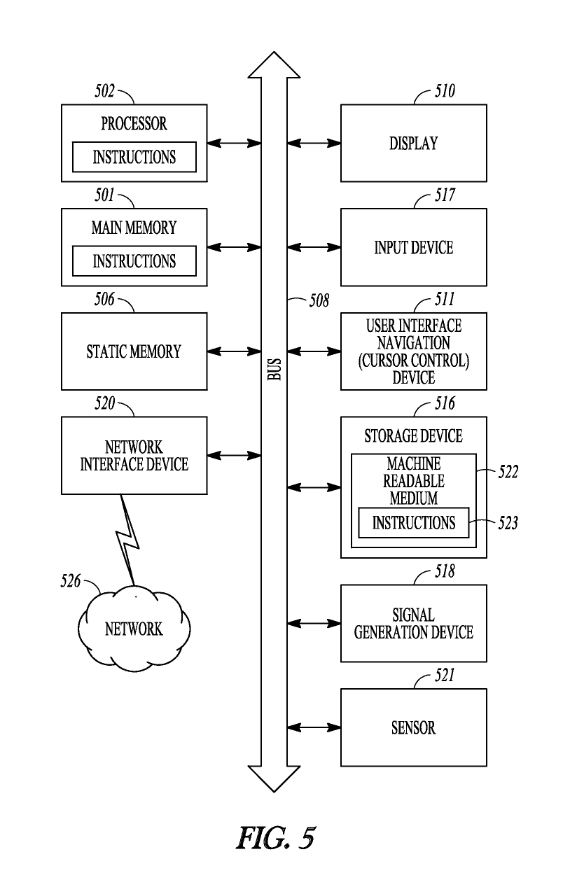

FIG. 5 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 501 and a static memory 506, which communicate with each other via a bus 508. The computer system 500 may further include a display unit 510, an alphanumeric input device 517 (e.g., a keyboard), and a user interface (UI) navigation device 511 (e.g., a mouse). In one embodiment, the display, input device and cursor control device are a touch screen display. The computer system 500 may additionally include a storage device 516 (e.g., drive unit), a signal generation device 518 (e.g., a speaker), a network interface device 520, and one or more sensors 521, such as a global positioning system sensor, compass, accelerometer, or other sensor.

The drive unit 516 includes a machine-readable medium 522 on which is stored one or more sets of instructions and data structures (e.g., software 523) embodying or utilized by any one or more of the methodologies or functions described herein. The software 523 may also reside, completely or at least partially, within the main memory 501 and/or within the processor 502 during execution thereof by the computer system 500, the main memory 501 and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 523 may further be transmitted or received over a communications network 526 using a transmission medium via the network interface device 520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A system comprising:
a processor; and
a memory device holding an instruction set executable on the processor to cause the system to perform operations comprising:
receiving from a profile of a user of an online social networking service one or more of a skill of the user, a major area of study of the user, and a degree earned by the user;
using profiles of other users of the online social networking service to identify the other users who have the same or similar skill as the user, the same or similar major area of study as the user, or the same or similar degree as the user;
extracting from the profiles of the identified other users one or more job types associated with the identified other users; and
providing to the user information relating to the one or more job types associated with the identified other users;
wherein the processor is coupled to a computer system of a career services center of a college or a university associated with the user; and
wherein the processor automatically extracts from the profile of the user, without intervention by the user, one or more of the skill of the user, the major area of study of the user, and the degree earned by the user, and the processor automatically suggests job types or job openings to the user by automatically transmitting an email or a text message to the user.

2. The system of claim 1, wherein the user is a college student, and the other users are professionally employed persons.

3. (canceled)

4. The system of claim 1, comprising an instruction set executable on the processor to cause the system to perform operations comprising identifying the other users who have attended the same college or university as the user.

5. The system of claim 4, wherein the other users who have attended the same college or university as the user are identified as a function of a particular job at a particular company.

6. The system of claim 1, comprising an instruction set executable on the processor to cause the system to perform operations comprising displaying suggestions to the user for locating a job based on one or more of the skills of the user, the major area of study of the user, and the degree earned by the user.

7. The system of claim 6, comprising an instruction set executable on the processor to cause the system to perform operations comprising receiving the suggestions for locating a job from the other users who have the same or similar skill as the user, the same or similar major area of study as the user, or the same or similar degree as the user.

8. The system of claim 1, comprising an instruction set executable on the processor to cause the system to perform operations comprising recommending one or more employers to the user as a function of one or more of a skill of the user, a major area of study of the user, and a degree earned by the user.

9. The system of claim 1, comprising an instruction set executable on the processor to cause the system to perform operations comprising presenting to the user an educational or professional path of another user who has one or more of the same or similar skill as the user, the same or similar major area of study as the user, and the same or similar degree as the user.

10. The system of claim 1, comprising an instruction set executable on the processor to cause the system to perform operations comprising adjusting, based on a profile of the user, the information relating to the one or more job types provided to the user.

11. The system of claim 1, comprising an instruction set executable on the processor to cause the system to perform operations comprising:
receiving input from the user regarding one or more job types desired by the user; and
adjusting the information relating to the one or more job types provided to the user based on the job types desired by the user.

12. The system of claim 1, comprising an instruction set executable on the processor to cause the system to perform operations comprising:
saving or deleting, based on input received from the user, the information relating to the one or more job types provided to the user; and
altering the information relating to the one or more job types provided to the user as a function of a history of saves or deletions by the user of the information relating to the one or more job types.

13. The system of claim 1, comprising an instruction set executable on the processor to cause the system to perform operations comprising suggesting one or more skills to the user to add to a profile of the user based on the skills in the profiles of the other users.

14. The system of claim 1, comprising an instruction set executable on the processor to cause the system to perform operations comprising:
determining one or more trends of a company associated with the information relating to the one or more job types; and
presenting the one or more trends to the user.

15. The system of claim 1, wherein the information relating to the one or more job types provided to the user comprises one or more of:
a job listing;
a listing of companies based on the skills, degree, and major of the user; and
tips relating to locating a job.

16. (canceled)

17. A computer readable medium comprising instructions that when executed by a processor execute a process comprising:
receiving from a profile of a user of an online social networking service one or more of a skill of the user, a major area of study of the user, and a degree earned by the user;
using profiles of other users of the online social networking service to identify the other users who have the same or similar skill as the user, the same or similar major area of study as the user, or the same or similar degree as the user;
extracting from the profiles of the identified other users one or more job types associated with the identified other users; and
providing to the user information relating to the one or more job types associated with the identified other users;
wherein the computer readable medium is coupled to a computer system of a career services center of a college or a university associated with the user; and
wherein the online social networking system extracts from the profile of the user one or more of the skill of the user, the major area of study of the user, and the degree earned by the user, and the online social networking system automatically suggests job types or job openings to the user by transmitting an email or a text message to the user.

18. The computer readable medium of claim 17, wherein the user is a college student, and the other users are professionally employed persons; and
wherein the computer readable medium is coupled to a computer system of a career services center of a college or a university associated with the college student.

19. A method comprising:
receiving, into a processor, from a profile of a user of an online social networking service one or more of a skill of the user, a major area of study of the user, and a degree earned by the user using profiles of other users of the online social networking service to identify the other users who have the same or similar skill as the user, the same or similar major area of study as the user, or the same or similar degree as the user;
extracting from the profiles of the identified other users one or more job types associated with the identified other users; and
providing to the user information relating to the one or more job types associated with the identified other users;
wherein the processor is coupled to a computer system of a career services center of a college or a university associated with the user; and
wherein the online social networking system extracts from the profile of the user one or more of the skill of the user, the major area of study of the user, and the degree earned by the user, and the online social networking system automatically suggests job types or job openings to the user by transmitting an email or a text message to the user.

20. The process of claim 19, comprising identifying the other users who have attended the same college or university as the user;
wherein the other users who have attended the same college or university as the user are identified as a function of a particular job at a particular company.
